(19) United States
(12) Patent Application Publication
(10) Pub. No.: US 2004/0064951 A1
(43) Pub. Date: Apr. 8, 2004

(54) Method of producing a workpiece having at least one bearing eye

(75) Inventors: Ulf G. Ederer, Mondsee-Tiefgraben (AT); Thomas Rumpf, Gmunden (AT); Elisabeth Schneiderbauer, Taufkirchen (AT)

Correspondence Address: Kurt Kelman, COLLARD & ROE, P.C., 1077 Northern Boulevard, Roslyn, NY, 11576, US

(73) Assignee: Miba Gleitlager GmbH

(21) Appl. No.: 10/678,669

(22) Filed: Oct. 3, 2003

(30) Foreign Application Priority Data
Oct. 4, 2002 (AT) A 1505/2002

(51) Int. Cl. B23P 17/00

(52) U.S. Cl. 29/898.12; 29/888.09

(57) ABSTRACT

A method of producing a workpiece (1) having at least one bearing eye (2) is described, an anti-friction coating (4) being galvanically deposited onto the bearing eye surface (3) after processing for a precise fit, which forms a running surface (5) having profiling in the form of groove-like recesses (6), which are distributed over the axial length and run around the circumference. In order to provide simple method conditions, it is suggested that the bearing eye surface (3) be processed for a precise fit to a circular cylinder before the anti-friction coating (4) is galvanically deposited onto the processed bearing eye surface (3) to form the running surface (5) in a varying thickness which corresponds to the final dimensions of the profiled running surface (5).

### 1. FIELD OF THE INVENTION

The present invention relates to a method of producing a workpiece having at least one bearing eye, an anti-friction coating, which forms a running surface having profiling in the form of groove-like recesses which run around the circumference and are distributed over the axial length, being galvanically deposited onto the bearing eye surface after processing for a precise fit.

### 2. DESCRIPTION OF THE PRIOR ART

In order to reduce the bearing noise of friction bearings for internal combustion engines, providing the peripheral surface of the bearing eye with profiling in the form of groove-like recesses which run around the circumference and are distributed over the axial length before an anti-friction coating is galvanically deposited onto this profiled bearing eye surface, which, due to the profiled bearing eye surface, forms a running surface which follows this profiling, is known (Austrian Patent 409 531 B). Through this analogous profiling of the running surface, the minimum bearing play to be preset to form a hydrodynamic lubricant wedge for complete lubrication may be reduced, because, due to the recesses running around the circumference, additional lubricant oil is available in the narrowest gap between the running surface and pins and, in addition, the axial displacement of the lubricant oil outward toward the two bearing sides is obstructed. The bearing noises are noticeably reduced by the smaller bearing play. However, the precisely fit profiling of the bearing eye surface which is necessary is complex, and in addition, the danger of penetration of the hard bearing eye material through the anti-friction coating rises with increasing wear in the land region between the groove-like recesses of the running surface.

### SUMMARY OF THE INVENTION

The present invention is therefore based on the object of implementing a method of producing a workpiece of the type initially described in such a way that, in spite of reduction of the production cost, a low-noise friction bearing which may carry a high dynamic load, and which has improved stability, is obtained.

This object is achieved according to the present invention in that the bearing eye surface is processed for a precise fit to a circular cylinder before the anti-friction coating is galvanically deposited onto the processed bearing eye surface to form the running surface in a varying thickness which corresponds to the final dimensions of the profiled running surface.

Since, due to the application of the anti-friction coating onto the bearing eye surface in a varying thickness which results in the desired profiling of the running surface, it is no longer necessary to profile the bearing eye surface, the bearing eye surface must only be processed for a precise fit to a circular cylinder. In addition, in the land region between the groove-like recesses, the danger of penetration of the bearing eye surface through the anti-friction coating in the event of partial wear is prevented, so that not only do simple production conditions result, but high stability may also be ensured. It is also to be noted in this context that during the galvanic deposition of the anti-friction coating, the deposition rate is a function of the particular current density and the current density typically has an influence on the proportions of the alloy elements of the anti-friction coating deposited. This means that the groove-like recesses may have a different hardness than the lands between these recesses, which may be advantageously exploited for the tribological properties of the anti-friction coating.

During the coating of a workpiece having a divided bearing eye, the bearing eye surface is processed for a precise fit after the divided bearing eye is assembled and then galvanically coated with the anti-friction coating before the anti-friction coating is divided by a fracture separation in accordance with the division of the bearing eye. Since the processing of the bearing eye surface for a precise fit is performed after the divided bearing eye is assembled, in order to provide the requirements for a tailored coating which ensures the final dimensions without reprocessing, after the anti-friction coating is applied in a thin layer, it must only be ensured that the anti-friction coating applied is divided in accordance with the division of the bearing eye, which is advantageously performed through a fracture separation. The comparatively low coating thickness and the good adhesion of the galvanically deposited anti-friction coating on the bearing eye surface represent advantageous conditions for fracture separation without problems.

For the galvanic coating of the bearing eye of the workpiece according to the present invention, a device for galvanic deposition of the anti-friction coating onto the bearing eye surface in an electrical field between the workpiece, which is connected as the cathode, and an anode coaxial to the bearing eye, may be used as the starting point. If the anode is provided with a texture tailored to the running surface profiling on its anode surface facing toward the bearing eye surface, shorter distances between the anode surface and the cathode surface formed by the circular cylindrical bearing eye surface result in the region of the later lands of the running surface profiling than in the region of the groove-like recesses between these lands. This results in a greater field strength and therefore a higher current density with a greater deposition rate in the land region.

In order that a uniform deposition of the anti-friction coating from the electrolyte liquid may be ensured around the circumference, the anode and the workpiece may be rotatably mounted around the bearing eye axis in relation to one another. Although generally a driven anode is constructively simpler to implement, it is, of course, also possible that not the anode, but rather the workpiece rotates.

The textured anode surface may be achieved in a typical way through a shaped design of the peripheral surface of the anode. However, it is also possible to equip the anode surface with electrically conductive bristles through a brush trimming, so that a correspondingly higher field strength results between the tips of the brush bristles and the bearing eye surface than in the adjoining regions. However, it must be ensured that the bristles of the brush trimming lie in the planes perpendicular to the axis, in order to allow the desired running surface profiling.

To amplify the field strength differences between the land regions and the regions of the groove-like recesses lying between them, the textured groove surface in the region of the profile grooves of the running surface may have electrical insulation. If a brush trimming is used, this electrical insulation may be achieved through an electrically insulating sheath for the bristles of the brush trimming.

The texturing of the anode surface, however, only represents one possibility of galvanically depositing the anti-friction coating onto the bearing eye surface while forming groove-like recesses around the circumference. Another possibility is for an electrolyte-permeable intermediate layer, which rotates in relation to the bearing eye, having an electrically insulating surface which presses against the bearing eye surface and is textured in a way tailored to the running surface profiling, to be provided between the bearing eye surface and the anode. Surprisingly, it has been shown that the anti-friction coating is deposited in a greater thickness than between the contact regions. Apparently, the contact regions are accordingly activated by the friction between the surface of the intermediate layer and the anti-friction coating growing on the bearing eye surface. The intermediate layer must meet multiple requirements, because the electrolyte liquid must flow through the intermediate layer and, in addition, mechanical abrasion of the deposited coatings must be prevented. These requirements may advantageously be met by an intermediate layer whose surface pressing against the bearing eye surface is made of a fabric. The profiling of the surface results from the intersection points between warp and weft, care having to be taken that these intersection points lie in the planes perpendicular to the peripheral axis of the intermediate layer, so that the desired running surface profiling is ensured. However, a brush-like covering of the anode, whose bristles ensure appropriate friction between the intermediate layer and the anti-friction coating as it forms, may also be used instead of the fabric.

If the workpiece is not to be rotated during the galvanic deposition of the anti-friction coating onto the bearing eye surface, it is advisable to position the intermediate layer on the anode, which is then rotatably mounted, because an intermediate layer between the anode and the bearing eye which rotates by itself requires additional constructive measures. However, using the anode as the carrier for the intermediate layer provides constructive advantages even if the anode is stationary and the workpiece rotates.

### BRIEF DESCRIPTION OF THE DRAWINGS

The method according to the present invention will be described in greater detail on the basis of the drawing.

FIG. 1 shows a device according to the present invention for coating the bearing eye of a workpiece with an anti-friction coating in a schematic block diagram,

FIG. 2 shows the anode surface diametrically opposite the bearing eye surface in detail in an axial section in an enlarged scale,

FIG. 3 shows an embodiment of a coating device altered in relation to FIG. 1.

FIG. 4 shows an intermediate layer provided between the anode and the bearing eye surface to be coated, as shown in FIG. 3, in detail in an axial section in an enlarged scale,

FIG. 5 shows a further embodiment of a device according to the present invention for coating a bearing eye in a schematic block diagram,

FIG. 6 shows a section along the line VI-VI of FIG. 5 in an enlarged scale, and

FIG. 7 shows an additional embodiment of a device according to the present invention for coating of a bearing eye in a schematic block diagram.

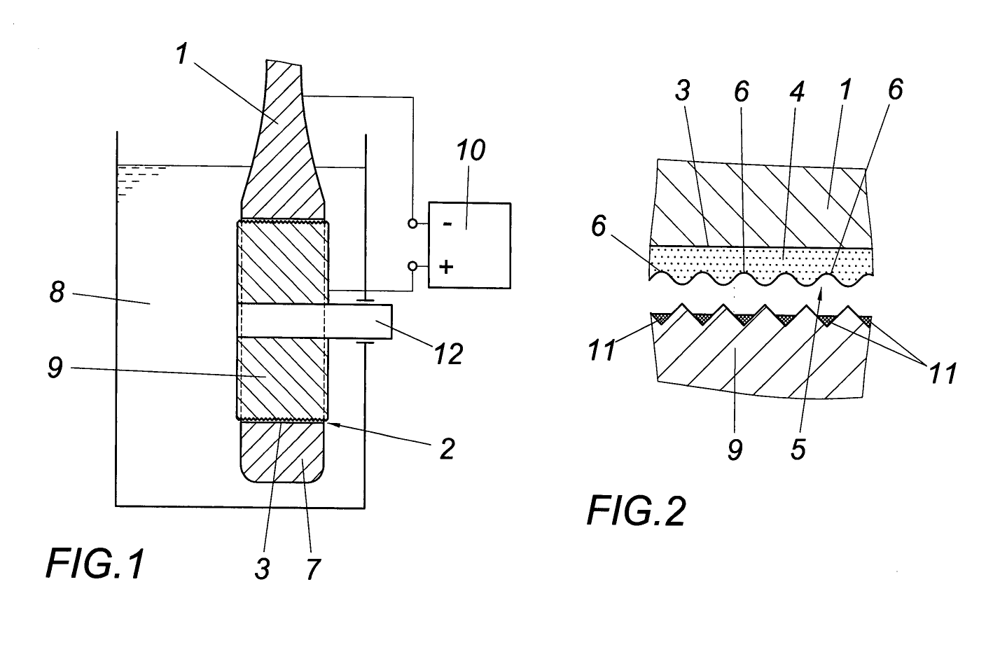

### DESCRIPTION OF THE PREFERRED EMBODIMENTS

In order to be able to coat a workpiece 1 having a bearing eye 2, such as a connecting rod, with an anti-friction coating 4 in the region of the bearing eye surface 3 in such a way that the running surface 5 formed by the anti-friction coating 4 receives profiling with groove-like recesses 6, which run around the circumference and are distributed over the axial length of the bearing eye 2, the running surface 3 of the bearing eye 2 is first processed for a precise fit to a circular cylinder. For a divided bearing eye 2, as shown in the drawing, this means that in the event of a preferred fracture separation of the workpiece, the bearing eye 2 is first divided along an intended fracture point before the separated bearing cover 7 is reattached for processing of the bearing eye surface 3 in order to be able to compensate for deformations of the workpiece 1 during the fracture separation due to brittleness occurring in the region of the intended fracture point, for example. After the processing of the running surface 3 for a precise fit corresponding to a circular cylinder, the workpiece 1 is prepared in a typical way for galvanic coating of the bearing eye surface 3 and introduced into a corresponding device 8. This device 8 has an anode 9, between which and the workpiece 1, connected as the cathode, an electrical field is built up as soon as the workpiece 1 and the anode 9 are connected to a corresponding DC network 10. Since the strength of the electrical field and therefore the current density, which is decisive for the deposition rate, is, if other conditions remain the same, a function of the distance between the cathode surface formed by the bearing eye surface 3 and the anode surface assigned to this cathode surface, through texturing of the anode surface tailored to the profiling of the running surface 5, a field strength distribution may be achieved over the axial length of the bearing eye 2 which, because of the different deposition rates resulting therefrom, ensures an anti-friction coating 4 having a running surface 5 profiled by groove-like recesses 6, as is shown in greater detail in FIG. 2. To amplify the field strength differences, the anode 9 may be provided with electrical insulation 11 in the region of the groove-like recesses 6 to be formed. In order that the deposition of the anti-friction coating 4 from the electrolyte liquid occurs uniformly around the circumference of the bearing eye 2, rotation of the anode 9 in relation to the workpiece 1 is to be ensured. This may be achieved by mounting the anode 9 on a driveshaft 12.

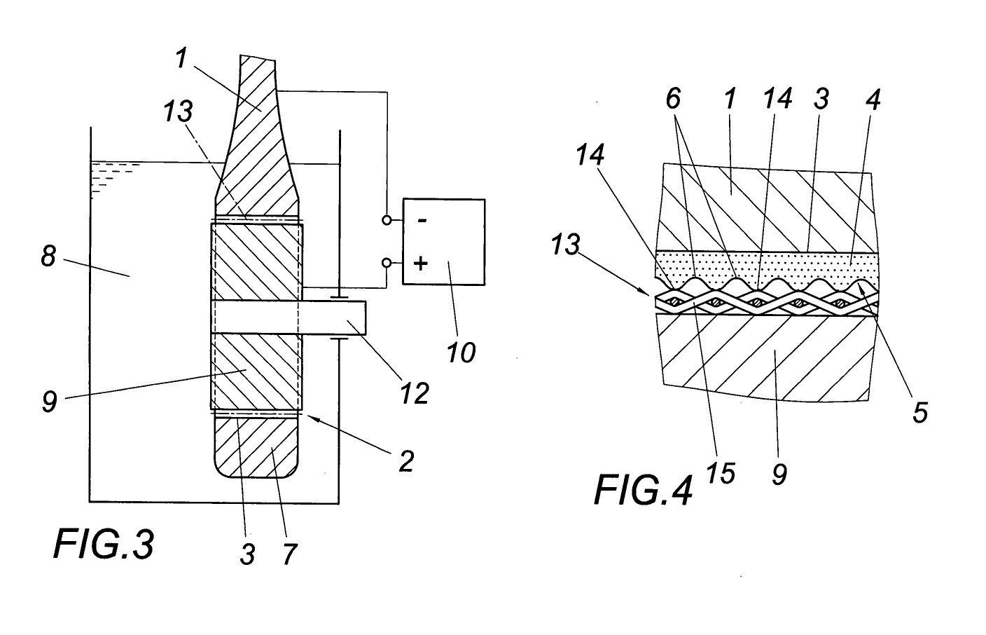

Another possibility of achieving galvanic deposition of the anti-friction coating 4 with a repeated varying thickness over the axial extension of the bearing eye 2 to form a running surface 5 having groove-like recesses 6 running around the circumference is shown in FIGS. 3 and 4. An intermediate layer 13 is provided between the anode 9 and the bearing eye surface 3 to be coated, which has a profiled electrically insulating surface corresponding to the running surface profiling, which presses against the bearing eye surface 3 and/or on the growing anti-friction coating 4, but only in the region of the later lands 14 between the groove-like recesses 6 of the running surface 5. As shown in FIG. 4, this profiled surface is formed by a fabric 15, whose thick points, formed by the intersection points of warp and weft, press against the bearing eye surface 3 and/or the growing anti-friction coating 4 and, upon a rotation in relation to the workpiece 1, ensure friction, which activates the growing anti-friction coating 4 in the friction region and ensures more rapid growth of the anti-friction coating than in the region outside these friction points. The attachment of the intermediate layer 13 to the anode ensures the required rotation of this intermediate layer 13 in a constructively simple way. Care must only be taken that the bearing eye surface 3 is supplied sufficiently with electrolyte liquid, which requires a corresponding permeability of the intermediate coating 13 to the electrolyte liquid. The electrolyte liquid may, for example, be supplied radially via the anode 9 for this purpose.

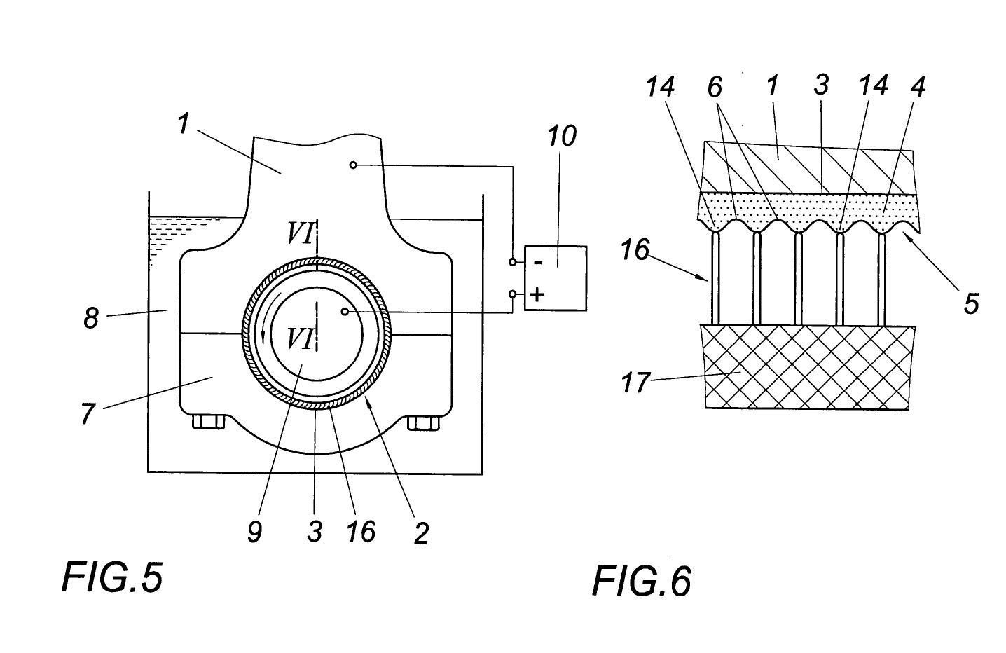

Instead of a fabric 15, the intermediate layer 13 may be made of a brush-like covering 16, as is shown in FIGS. 5 and 6. The bristles of the brush-like covering 16, which are arrayed next one another in lines in the axial direction, activate the galvanic deposition of the anti-friction coating 4 in their peripheral region, which leads to greater thickness growth than in the intermediate regions between the lines of bristles. In contrast to the implementation of the galvanic device 8 shown in FIG. 3, the workpiece 1 and the anode 9 are fixed non-rotatably according to the exemplary embodiment shown in FIG. 5. Only the brush-like covering 16 positioned on a separate support ring 17 is driven in rotation. In this exemplary embodiment as well, measures must be taken for sufficient supply of electrolyte liquid to the bearing eye surface 3 to be coated.

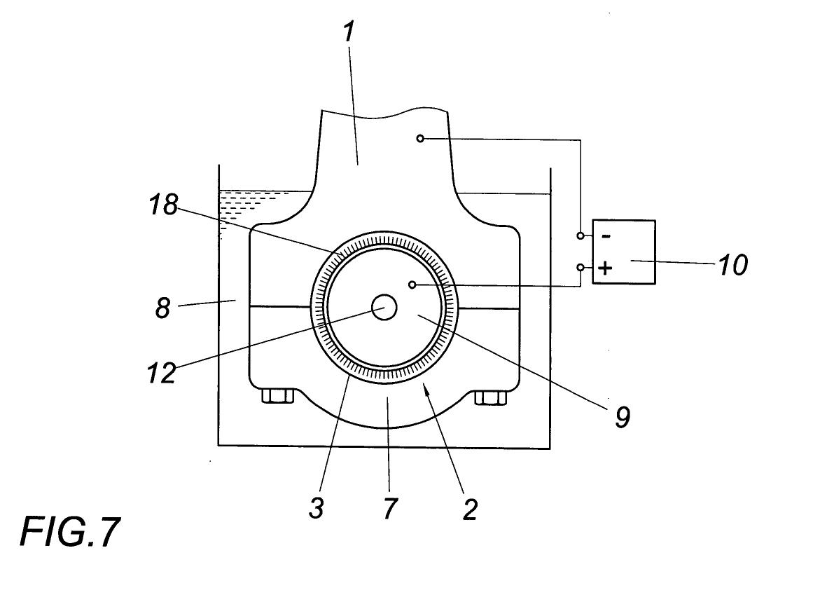

Finally, it may be inferred from FIG. 7 that a shaping design is not required for texturing the anode surface if the anode surface diametrically opposite the bearing eye surface 3 is provided with a brush trimming 18 having electrically conductive bristles, so that the bristle ends determine the electrical field built up between the brush trimming 18 and the bearing eye surface 3 in regard to the field strength distribution. Due to the higher field strengths in the region of the bristle lines, higher deposition rates for the anti-friction coating result, which leads to the desired profiling of the running surface 5. The bristles of the brush trimming 18 may additionally be provided with an electrically insulating sheath, in order to increase the field strength differences between the regions of the bristle lines and the intermediate gap regions.

What is claimed is:

1. A method of producing a workpiece having at least one bearing eye, an anti-friction coating being galvanically deposited onto the bearing eye surface after processing for a precise fit, which forms a running surface having profiling in the form of groove-like recesses, which are distributed over the axial length and run around the circumference,
characterized in that the bearing eye surface is processed for a precise fit to a circular cylinder before the anti-friction coating is galvanically deposited onto the processed bearing eye surface to form the running surface in a varying thickness which corresponds to the final dimensions of the profiled running surface.

2. The method according to claim 1,
characterized in that, for a workpiece having a divided bearing eye, the bearing eye surface is processed for a precise fit after the assembly of the divided bearing eye and is then galvanically coated with the anti-friction coating before the anti-friction coating is divided by a fracture separation in accordance with the division of the bearing eye.

3. A device for producing a workpiece (1) having at least one bearing eye (2), on whose bearing eye surface (3) an anti-friction coating (4) is deposited, which forms a running surface (5) having profiling in the form of groove-like recesses (6), which are distributed over the axial length and run around the circumference, comprising a device (8) for galvanic deposition of the anti-friction coating (4) onto the bearing eye surface (3) in an electrical field between the workpiece (1), which is connected as the cathode, and an anode, which is coaxial to the bearing eye (2), characterized in that the anode (9) has a texture of its anode surface, which is tailored to the running surface profiling, facing toward the bearing eye surface (3).

4. The device according to claim 3,
characterized in that the anode (9) and the workpiece (1) are mounted rotatably in relation to one another around the bearing eye axis.

5. The device according to claim 3 or 4,
characterized in that the anode surface is textured by a brush trimming (18) having electrically conductive bristles.

6. The device according to one of claims 3 through 5,
characterized in that the structured anode surface has electrical insulation (11) in the region of the groove-like recesses (6) of the running surface (5).

7. The device according to claims 5 and 6,
characterized in that the bristles of the brush trimming (18) have an electrically insulating sheath.

8. A device for producing a workpiece (1) having at least one bearing eye (2), on whose bearing eye surface (3) an anti-friction coating (4) is deposited, which forms a running surface (5) having profiling in the form of groove-like recesses (6), which are distributed over the axial length and run around the circumference, comprising a device (8) for galvanic deposition of the anti-friction coating (4) onto the bearing eye surface (3) in an electrical field between the workpiece (1), which is connected as the cathode, and an anode (9), which is coaxial to the bearing eye (2),
characterized in that an electrolyte-permeable intermediate layer (13), which rotates in relation to the bearing eye (2) and has a textured, electrically insulating surface which presses against the bearing eye surface (3) and is tailored to the running surface profiling, is provided between the bearing eye surface (3) and the anode (9).

9. The device according to claim 8,
characterized in that the intermediate layer (13) is positioned on the anode (9), which is mounted rotatably in relation to the bearing eye (2).

10. The device according to claim 8 or 9,
characterized in that the surface of the intermediate layer (13) which presses against the bearing eye surface (3) is made of a fabric (15).

11. The device according to claim 8 or 9,
characterized in that the intermediate layer (13) is made of a brush-like covering (16).
